(19) United States
(12) Patent Application Publication
(10) Pub. No.: US 2006/0243463 A1
(43) Pub. Date: Nov. 2, 2006

(54) Rotatable implement with end-mounted motor

(76) Inventor: Donald L. Mensch, Byron Center, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/119,092

(22) Filed: Apr. 29, 2005

(51) Int. Cl. A01B 63/00

(52) U.S. Cl. 172/245

(57) ABSTRACT

An implement for mounting on a working vehicle includes a frame with side supports. A rotatable implement head includes a cross tube supported for rotation between the side supports. The drive assembly is positioned partially within the cavity in a protected position, such that it extends minimally outwardly, allowing the head to closely engage obstacles without interference from the motor. A motor mount also includes a tubular flange protecting the motor. A non-circular motor-driven tubular drive member extends telescopingly into a driven member attached to and located within the cross tube. A plastic coupler fits between the driven member and the drive member to take up clearance therebetween. The arrangement can be used on different implement heads, such as an angularly-adjustable power-sweeper/brush, a tined rake/ground-preparing cultivator, and/or a silage facer movable vertically across the face of a bucket.

### BACKGROUND

The present invention relates to implements adapted for mounting on working vehicles such as tractors, front-end loaders, four-wheel utility vehicles, and the like; and in particular relates to implements having powered rotating implement heads, such as power brushes, rakes, silage facers, and the like.

It is desirable to provide powered implements adapted for outdoor use that have improved durability, while maintaining a low cost, robustness, and preferably while maintaining a level of simplicity and ease of maintenance. One important aspect is to build the power equipment in a manner that provides protection for its critical and expensive components, such as its drive mechanisms. In particular, it is desirable to position these critical expensive components in locations where they are protected from dirt and abuse from exterior obstacles, yet in positions where they are easy to access, maintain, and repair. Also, it is desirable to provide implements that utilize interchangeable components that are adapted for different uses, and yet that permit flexible attachment to different working vehicles. Also, it is desirable to provide a drive mechanism that is adjustable and adaptable to widely different implement heads.

Nelson U.S. Pat. No. 3,795,279 discloses a soil stabilizer with rotating drum having an end-mounted hydraulic drive. However, the drive (20) is bolted to an outboard side of a lifting arm (9) in a position where the drive may be subjected to striking obstacles. Also, Nelson '279 teaches using bearings (25) positioned on an exterior surface of its rotating drum and further teaches using a face-type seal (28) on an inboard side of the bearings for controlling dirt infiltration. This arrangement is potentially expensive due to its complexity, its requirement for machined surfaces, and also due to its requirement of multiple parts and pieces that must be welded and bolted together. Also, it is noted that multiple components must be removed in order to repair and/or replace the bearings (25).

It is known to place a drive mechanism at an end of and in axial alignment with a rotating implement head. For example, Kuhn U.S. Pat. No. 4,512,414 discloses a rotary tiller, Taylor U.S. Pat. No. 4,704,045 discloses an asphalt pulverizer, and Lewis U.S. Pat. No. 6,467,432 discloses a litter-handling implement, each of which have end-mounted hydraulic drive mechanisms. However, in each of these apparatus, the drive mechanisms protrude from an end of the rotating drums in locations where the drive mechanisms are exposed and subject to striking obstacles (such as trees, walls, buildings, fence posts, etc) if the vehicle operator is not careful. Also, the protruding positions of the drive mechanisms prevent the rotary mechanisms from being operated very close to the obstacles, since the drive mechanisms take up space around a side and end of the apparatus. It is desirable to provide a drive system that is not subject to interferingly striking obstacles, and that, if an obstacle is struck, is not subject to a larger torsional destructive loading. Also, it is desirable to provide a drive mechanism that does not prevent a rotating implement head from being operated close to obstacles.

Hueftle U.S. Pat. No. 3,878,952 discloses a silage bucket with chain driven loading rake.

Also, Slaby U.S. Pat. No. 5,495,987 discloses a chain-driven silage facer. Notably, the chain driven mechanisms have problems associated with chains, such as high maintenance, safety, and durability issues.

Thus, a system having the aforementioned advantages and solving the aforementioned problems is desired.

### SUMMARY OF THE PRESENT INVENTION

In one aspect of the present invention, an implement adapted for mounting on a powered vehicle includes a frame adapted for attachment to the powered vehicle and including opposing side supports. The implement further includes a rotatable implement head extending between the side supports and defining a cavity in at least one end of the implement head. A motor is positioned at least partially within the cavity in a protected position and coupled to the implement head for rotatably driving the implement head.

In another aspect of the present invention, an implement includes a frame adapted for attachment to the powered vehicle and including opposing side support plates, a rotatable implement head extending between the side support plates and defining an axis of rotation, and a motor attached to one of the side support plates. The motor includes a power-generating part positioned at least partially inboard of the one side support plate in a position generally aligned with the axis of rotation of the implement head so that an exterior portion of the motor extends axially outwardly from the one side support plate less than a length of the power-generating part of the motor. By this arrangement, the implement head can be positioned closer to an obstacle than the length of the motor even though the motor is positioned in-line with the axis of rotation of the implement head.

In another aspect of the present invention, an implement adapted for mounting on a powered vehicle includes a frame adapted for attachment to the powered vehicle, and an implement head supported for rotation on the frame. The implement head includes a non-circular tubular driven member coupled to and adapted to rotatably drive the implement head. A drive assembly includes a motor anchored to the frame, a non-circular tubular drive member shaped to fit telescopingly into the driven member, and a coupler shaped to fit matably between the driven member and the drive member to take up clearance therebetween. In a narrower form, the coupler is made of a plastic material.

In another aspect of the present invention, an implement adapted for mounting on a powered vehicle includes a frame having a pair of spaced apart side support plates, a rotatable implement head including a tube section defining a cavity inboard of and adjacent one of the side support plates, and a motor drive assembly including a motor. A mount is provided having a first flange attached to the one side support plate and a tubular flange that extends telescopingly into the cavity from the one support plate, with the motor being positioned at least partially within the tubular flange.

In still another aspect of the present invention, a method of assembling implements includes steps of providing a plurality of different frames including at least a first frame that provides an adjustable head support and a second frame that provides a different adjustable head support, providing a plurality of different implement heads configured to be supported on at least one of the different frames, and providing a plurality of identical drive motors. The method further includes selecting the first frame and a first one of the implement heads and attaching one of the drive motors operably to the first frame and to the first one implement head to drive the implement head, and still further includes selecting the second frame and a second one of the implement heads and attaching another one of the drive motors operably to the second frame and to the second one implement head to drive the second one implement head. In a narrower aspect, the implement heads include a power-sweeper/brush, a tined rake/ground-preparing cultivator, and a silage facer. Also in a narrower aspect, the different frames include an angularly adjustable frame and also a bucket with a sub-frame movable vertically across a face of the bucket.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are perspective assembled and perspective exploded views of a power rake implement, FIG. 1A being a side view showing the implement on a powered working vehicle;

FIGS. 3-4 are top and cross-sectional views of the implement head of FIG. 1;

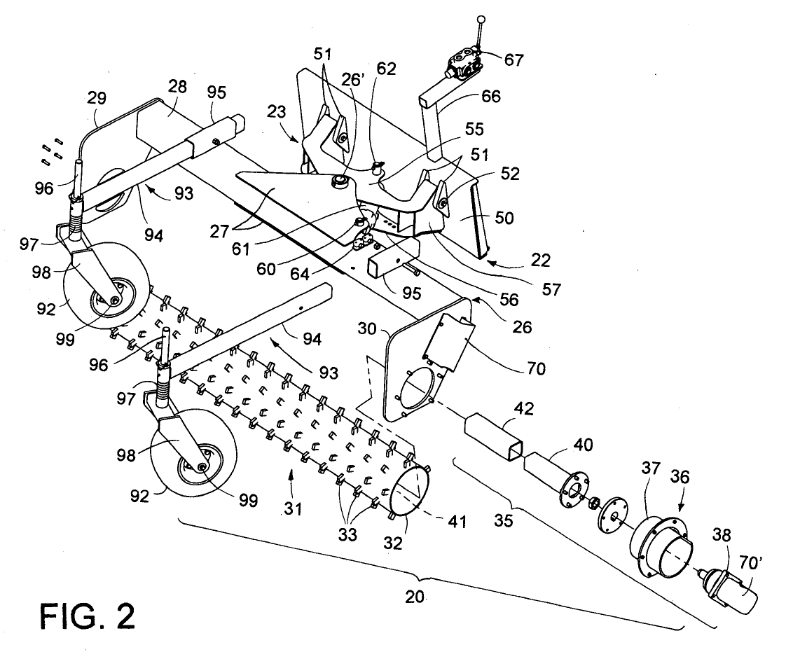

FIG. 5 is an enlarged view of the hydraulic motor/drive assembly as assembled to an end of the rake head, and FIG. 6 is a similar view but with the rake head removed to more clearly show the drive assembly;

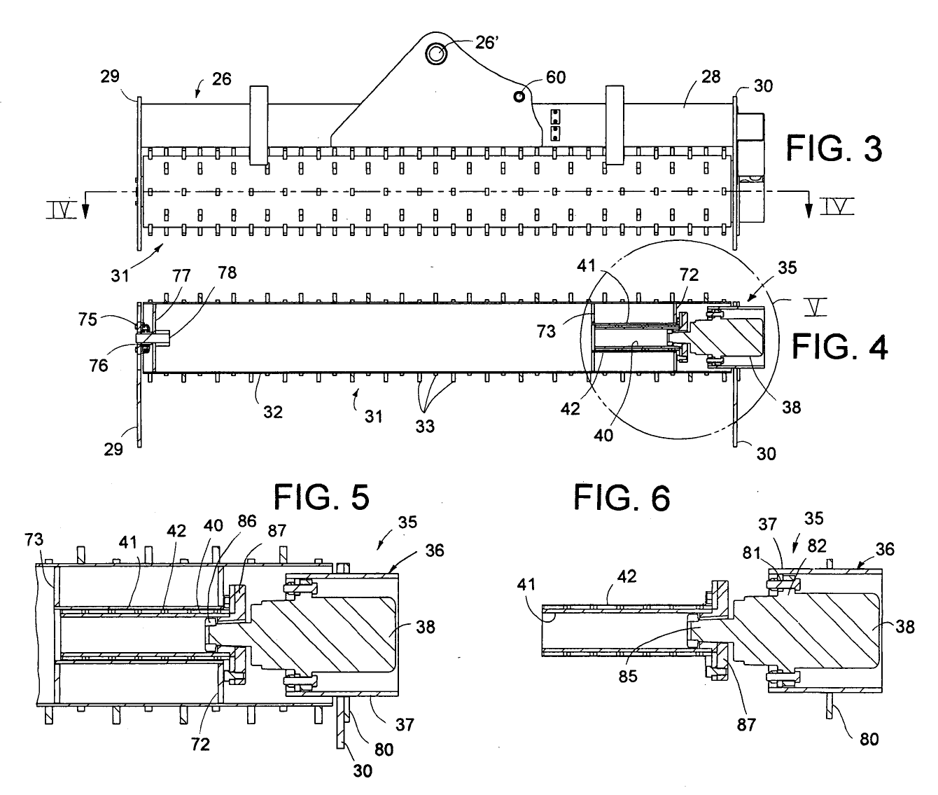

FIGS. 7-9 are top, cross-sectional and exploded perspective views of the rake head;

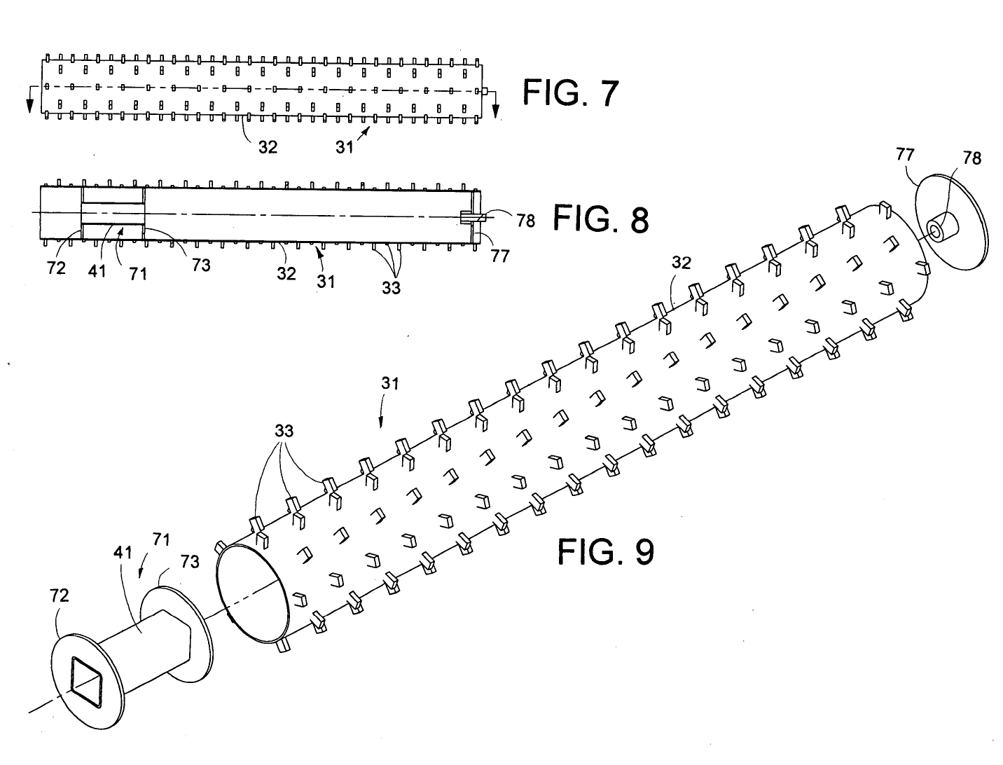

FIG. 10 is an exploded perspective view of the drive assembly;

FIGS. 11-12 are perspective assembled and perspective exploded views of a power broom implement; and

FIGS. 13-14 are perspective assembled and perspective exploded views of a power silage facer and bucket implement.

### DETAILED DESCRIPTION OF PREFERRED EMBODIMENTS

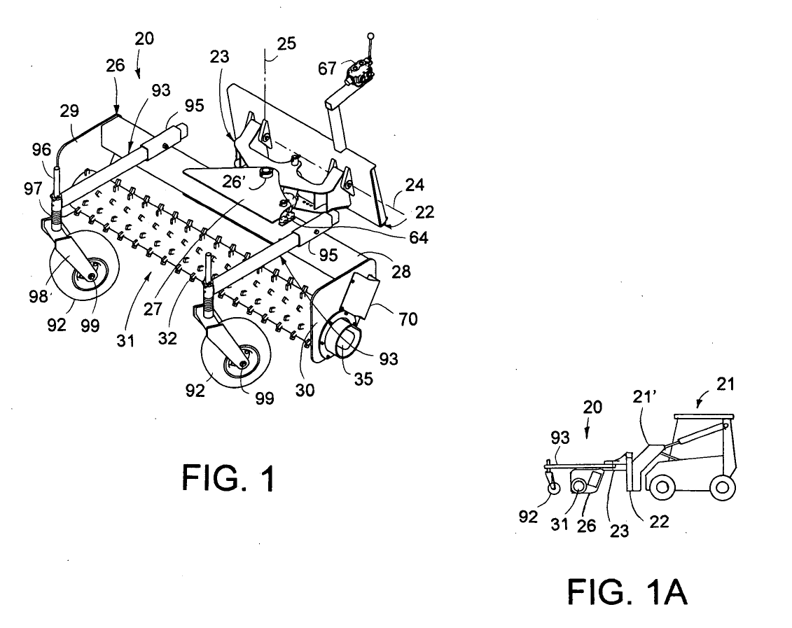

An implement 20 (FIGS. 1, 1A, and 2) for mounting on a working vehicle 21 includes a vehicle-attached frame 22 attached to lift 21′ of the vehicle 21, an angularly adjustable sub-frame 23 attached to the frame 22 for angular adjustment about a horizontal axis 24, and an implement-carrying frame 26 pivoted to the sub-frame 23 for angular adjustment about a vertical axis 25. The implement-carrying frame 26 is attached to the vehicle-attached frame 22 by a pivot pin 26′ that extends vertically through horizontal deck plates 27 welded to top and bottom surfaces of a frame cross tube 28. Side support plates 29 and 30 (also called “side supports” herein) are welded to ends of the cross tube 28. A drive assembly 35 is mounted to the support plate 30 and extends horizontally inwardly through the support plate 30 in a protected position and extends to a location partially within a rotatable cross tube 32 (also called a “drum”) on a head 31 of the implement 20, offering advantages in terms of protection to the drive assembly 35 that rotates the implement head 31. The inset position of the drive assembly 35 also allows the implement head 31 to be operated more closely to an obstruction, since the drive assembly 35 does not extend outwardly from the implement 20 as far as it would if the drive assembly 35 were not recessed.

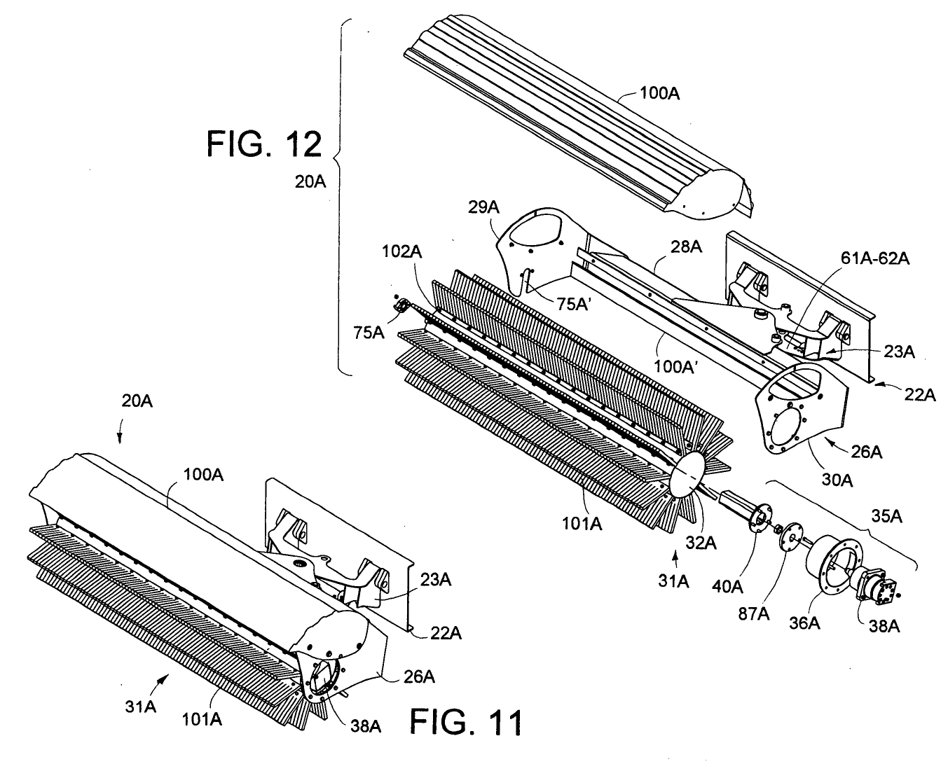

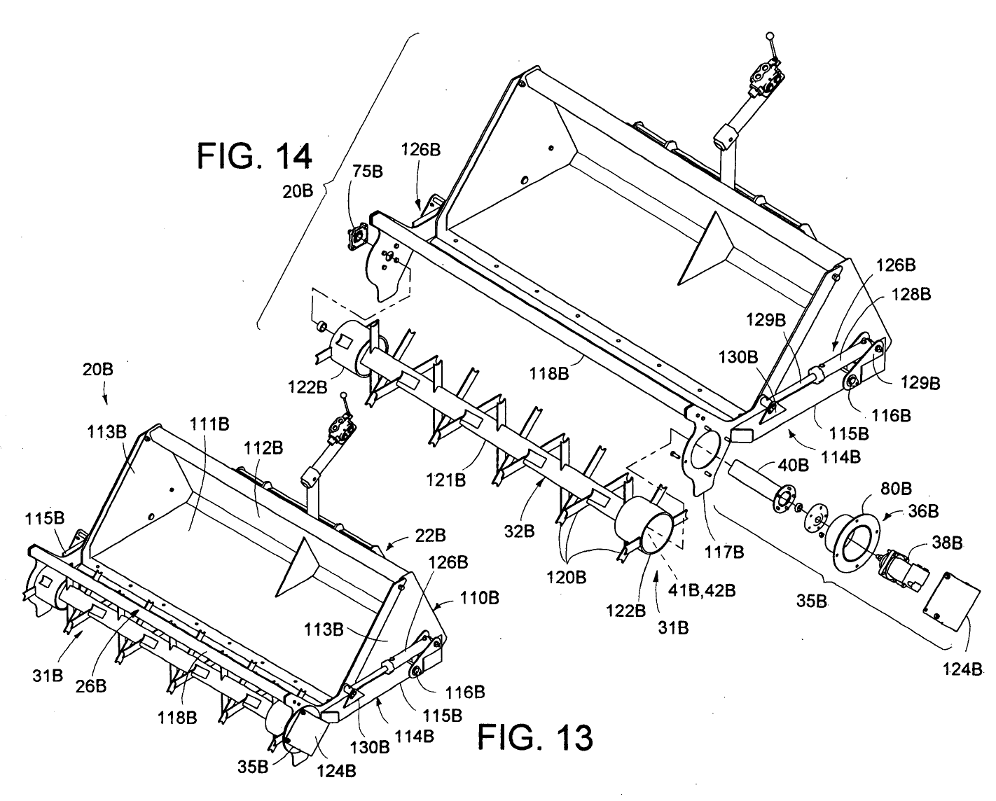

The illustrated implement 20 is configured for power raking at horizontally-adjustable angles of attack, and includes a rotatable implement head 31 having an implement head cross tube 32 (also called a “drum” or tube section”) supported for rotation between the side supports 29 and 30, with short projecting tines 33 extending radially from the surface of the tube 32. The drive assembly 35 extends through an aperture in the side support plate 30, and is positioned partially within the cavity inside the implement head cross tube 32 in a protected position. Notably, a motor mount 36 for attaching the drive assembly 35 to the side support plate 30 includes a sleeve-like cylindrical flange 37 that also surrounds and protects the motor 38 of the drive assembly 35. By this arrangement, the motor 38 and drive assembly 35 extend only minimally outwardly from the side support plate 30, such as only about 2 or 3 inches, allowing the implement head 31 to be positioned very close obstacles without the motor or drive assembly 35 interfering with the close positioning. The drive assembly 35 includes a non-circular motor-driven tubular drive member 40 (i.e., a 3 inch×3 inch square tube section) that extends telescopingly into a driven member 41 (i.e., a 4 inch×4 inch square tube section) attached to and located within the implement head cross tube 32. A plastic coupler 42 (also called an “adapter” herein) fits between the drive member 40 and the driven member 41 to take up clearance therebetween. As will be apparent from the discussion below, the arrangement can be used on different implement heads, such as the tined rake/ground-preparing cultivator (FIGS. 1-2), an angularly-adjustable power-sweeper/brush (FIGS. 11-12), and/or a silage facer movable vertically across the face of a bucket (FIGS. 13-14).

It is noted that a variety of powered working vehicles (see exemplary vehicle 21 in FIG. 1A) are known and available in the public, such as front and rear loader tractors, skid-steer loaders, front-end loaders such as Bobcat™ four-wheel utility vehicles, fork trucks, and other vehicles adapted for doing work. Concurrently, attachment to such vehicles and to the lifting arms of such vehicles are also known, and it is therefore not necessary to describe in detail each and every such arrangement. The present disclosure illustrates two such attachment apparatus, including a first arrangement that provides adjustment of an implement angularly in both vertical and horizontal directions (FIGS. 1 and 11) and also an arrangement that provides vertical translational adjustment of an implement across and in front of a bucket (FIG. 13). However, it is contemplated that additional adjustable arrangements are possible and are intended to be covered by the present inventive concepts.

As noted above, the power rake implement 20 (FIGS. 1-2) includes a vehicle attached frame 22. The illustrated vehicle attached frame 22 includes a mounting plate 50 having top and bottom edge flanges and right and left stiffening ribs for strength of the mounting plate 50. Protruding mounts 51 extend from a front of the plate 50 and include holes adapted to receive horizontal pivot pins 52.

The illustrated vertically-angularly-adjustable sub-frame 23 includes top and bottom decks 55 and 56 with rearwardly extending sections connected by vertical reinforcement ribs 57 and 58 on each side. The ribs 57 and 58 combine with the rearwardly extending sections to form box-like sections. Holes are formed therein that align with the holes in the mounts 51 on a face of the frame 22 for receiving the pivot pins 52. The pivot pins 52 define the horizontal axis 24. An additional pivot pin can be provided for defining a three-point attachment, as is common when connecting an implement to a power vehicle 21 (see FIG. 1A). Optionally, the bottom connection can instead include a hydraulically-extendable cylinder so that the sub-frame 23 can be angularly rotated about the horizontal axis 24. This allows the horizontal angle of attack for the implement 20 to be changed. It is also contemplated that the vehicle attached frame 22 could present a three (or more) point attachment arrangement adapted for automatic attachment to a mating connection/attachment system on a working vehicle (21).

The horizontally-angularly-adjustable implement-carrying frame 26 (FIG. 2) includes the cross tube 28 to which top and bottom deck plates 27 are welded. A pair of rear-located aligned “primary” holes are formed along a protruding rear part of the deck plates 27 for receiving vertical pin 26′. The vertical pin 26′ defines the vertical axis 25. Secondary aligned holes are formed in the deck plates 27 at locations spaced laterally from the first holes for receiving a vertical pin 60. A cylinder 61 and extendable piston are connected between the sub-frame 23 and second holes 62 on the sub-frame 23 for providing horizontal angular adjustment of the implement-carrying frame 26 relative to the sub-frame 23. Quick connects 64 are positioned on or close to the top deck plate 27 at a location near the vertical pivot axis 25. The quick connects 64 are connected to hydraulic lines that extend along the cross tube 32 to the drive motor 38, and are positioned for connection to the hydraulic lines that extend to and from a hydraulic pressure source on the powered working vehicle 21 to the implement for completing a hydraulic circuit. A stanchion 66 extends upwardly and rearwardly from the mounting plate 50, and hydraulic controls 67 are located on the stanchion 66 in a position for easy access. For example, it is contemplated that an extension rod 67′ can be connected to the hydraulic controls 67 so that the implement 20 can be operated while seated in the powered working vehicle 21.

The side support plates 29 and 30 provide a double function by providing support for carrying the rotatable implement head 31 and by also acting as side shields to contain debris generated by rotation of the implement head 31. Protective bumper brackets 70 and 70′ are attached to the support plate 30 for providing additional protection to the drive assembly 35. The protective bumper bracket 70 can be any size and shape as desired. The illustrated bracket 70 extends about 2 to 3 inches outboard (i.e., sufficiently to work for its intended purpose of protecting the exposed outer end of the drive assembly 35).

As noted above, the implement head 31 includes the cross tube 32 that fits between side support plates 29 and 30. In practice, a clearance of about ¼ to ½ inch is provided from the end of the implement cross tube 32 to the support plates 29 and 30, though more or less clearance can be provided as desired. Tines 33 project radially from the cylindrical outer surface of the cross tube 32 at circumferentially-spaced and axially-spaced intervals. An adapter 71 (FIGS. 8-9) is positioned inside of and welded to the cross tube 32 at an end of the cross tube 32 near the support plate 30. The adapter 71 includes two (or more) of spaced-apart disks 72 and 73 that support the driven member 41 within the cross tube 32 at a location axially aligned with the longitudinal centerline and axis of rotation of the cross tube 32. The illustrated driven member 41 is formed by 4 inch×4 inch tube section. A rotational bearing 75 (FIG. 4) is located in a hole 76 on the support plate 29 at the other end of the cross tube 32. An end disk 77 is welded to an end of the cross tube 32, and includes a centered axle 78 protruding laterally. The axle 78 rotatably engages the rotational bearing 75 for supporting rotation of the implement head 31 at one end, and the other end of the implement head 31 is supported for rotation by bearing located within the wheel motor 38. Wheel motors are well known in the art and are well developed for handling the stresses associated with the intermediate level of stresses associated with the “heavy-duty” implements disclosed herein. Specifically, the stresses on the implement head 31 at the end near the support plate 29 are transmitted from the implement cross tube 32 through end disk 77 to axle 78 to bearing 75 to support plate 29 and to implement-carrying frame 26, sub-frame 23, and vehicle-engaging frame 22, respectively. Further, stresses on the implement head 31 at other end near the support plate 30 are transmitted from the implement cross tube 32 through the disks 72/73 to driven members 40-42 through the wheel motor 38 to motor mount 36 and to support plate 30. In turn, the stresses are transmitted through the implement-carrying frame 26, sub-frame 23, and vehicle-engaging frame 22, respectively. Notably, the support plate 30 and the disks 72/73 (especially outer disk 72) are positioned relatively close together, such that “unbalanced” torsional loads are minimized. Also, the components 40-42 are elongated, and also the wheel motor 38 and motor mount 36 are relatively short and reinforced, such that the arrangement is able to handle any torsional loads that are generated. Testing has shown this arrangement to be satisfactory for the stresses and loads of the present implements.

The mount 36 (FIG. 2) for drive assembly 35 is tubular and forms a housing around the motor 38 that protects and houses the motor 38. Specifically, the mount 36 includes the cylindrical flange 37 and also includes an annular ring-like attachment flange 80 with holes that align with holes in the support plate 30. Bolts extend through the holes to secure the mount 36 to the support plate 30. A mounting plate 81 is welded within the cylindrical flange 37 and includes surfaces and holes for engaging the mounting flange 82 on motor 38 for securing the motor 38 in place. The cylindrical flange 37 extends in an inward direction through the support plate 30 to a location within the outer end of the implement cross tube 32. By this arrangement, it overlaps with the implement cross tube 32 such that it both protects the motor 38 and also acts to shield the motor from much of the dirt and debris generated by operation of the implement head 31.

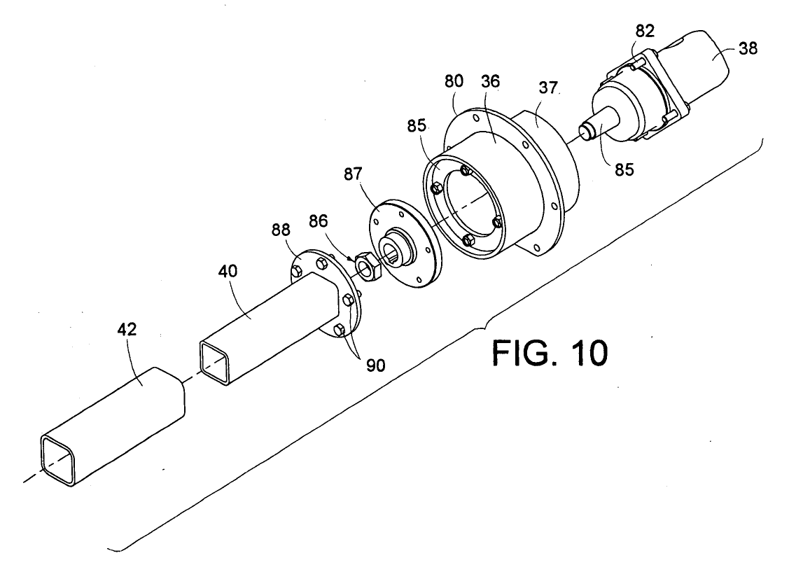

The drive assembly 35 (FIG. 10) includes the motor 38, the tubular drive member 40, and the plastic sleeve coupler 42 that fits between the drive member 40 and the mating driven member 41. The plastic coupler 42 takes up space between the members 40 and 41 and also acts to dampen vibrations and shocks transmitted from the implement head 31 toward the motor 38. The motor 38 is a high torque low speed hydraulic motor adapted to be driven by a remote source of hydraulic pressure, such as is often available on powered working vehicles 21. The motor 38 includes a motor shaft 85. A wheel motor hub 87 is attached to the motor shaft 85 by a motor shaft nut 86 that threadably engages the shaft 85, and is keyed to the shaft 85 for rotation therewith. The motor hub 87 has an annular flange shaped to matably engage and be bolted to an end plate 88 on the square-shaped tubular driven member 40 to rotatably drive the member 40. The illustrated end plate 88 is adapted to engage an outer end of the disk 73 for controlling an axial position of the implement cross tube 32 relative to the support plate 30. A second annular plate could be formed on an outer end of the plastic coupler 42 if desired to dampen axial movement. As illustrated, the headed ends of the bolts 90 engage the outer disk 73.

It is contemplated that other attachment arrangements can also be provided, such as keyed or shear pin arrangements. However, the present arrangement is both simple in construction and effective in operation. In particular, the present driving arrangement including the plastic adapter 42 permits some axial movement and also provides both axial and radial dampening of vibrations generated by the implement head 31.

The implement 20 (FIGS. 1-2) includes forward wheels 92 supported by arms 93. The arms 93 each include a forwardly extending horizontal section 94 that telescopingly engages a tube mount 95 welded atop the cross tube 28, one mount 95 being located on each side of the cross tube 28. The wheel-supporting arms 93 further include a vertical leg 96 supported at a front of the horizontal sections 94 by a shock absorber 97. Straddle brackets 98 extend from a bottom of the vertical leg 96 and support an axle 99 on which the wheels 92 are mounted. The straddle brackets 98 and vertical legs 96 are rotatable so that they re-orient when the vehicle 21 (and hence the implement 20) is steered toward a new direction. It is contemplated that the implement 20 could include a skirt or top cover to contain debris during operation of the implement head 31.

The assembly of the drive system is as follows. First, the drive assembly 35 is assembled. The hydraulic wheel motor 38 is bolted to the motor mount 36 (also called a motor housing). Then the wheel motor hub 87 and motor shaft nut 86 are assembled to the end of the motor shaft. Now the drive member 40 (also called a drive tube assembly) is bolted to the wheel motor hub 87 and the plastic insert coupler 42 is slipped over the drive tube assembly 40. Then the drive assembly is inserted into the rake head 31. The plastic insert 42 will drive against the driven member 41 (also called a head drive tube) and turn the rake head 31. The wheel motor 38 will act as the carrier for that side of the rake head 31.

In operation, the implement 20 is attached to a front of a powered working vehicle 21, such as to its vertically lifting arms, and hydraulic lines on the utility working vehicle 21 are connected to the quick connects 64 as well as the remote control rods are connected to the hydraulic controls 67. The working vehicle 21 is then moved to a location of operation, rotation of the implement head 31 started by supplying hydraulic pressure to the hydraulic motor 38, and the implement 20 lowered to a use position. The hydraulic power is provided to the implement head 31 at a location in an axial alignment to the implement head 31, which provides for mechanical simplicity, robustness and durability. Further, the motor 38 is in a protected position, both in terms of low dirt intrusion and also in terms of being positioned where it is less likely to engage obstructions passing near an end of the implement 20. Where the working vehicle 21 has lift arms 21′ that permit angular rotation of the implement 20 (either vertically or horizontally), or where the frame (26) is angularly adjustable via a hydraulic mechanism (61/62).

The illustrated implement 20 has a drive assembly 35 positioned at one end of the implement head 31, and a bearing 75 positioned at the other end, each carrying a weight of the implement head 31 and simultaneously supporting it for rotation. It is contemplated that a drive assembly 35 could be positioned at both ends if desired.

Two additional implements 20A and 20B are shown in FIGS. 11-12 and 13-14, respectively. Similar or identical components are identified using identical numbers, but with the additional of the letters “A” and “B”. This is done to reduce redundant discussion. At the same time, even if different numbers are used, it is for convenience and not for another reason.

Implement 20A (FIGS. 11-12) includes a power broom implement head 31A. The frames 22A, 23A and 26A are identical to the frames 22, 23, and 26, discussed above, with the exception that the frame 26A is modified to reflect the fact that the implement head 31A is a broom and therefore does not need to dig into the ground like the implement head 31. Also, the implement 20A requires more room for the implement head 31A since the bristles of the broom head are longer, and also generate more dust. Hence, the frame cross tube 28A is positioned lower and more rearward on the side support plates 29A and 30A. The side support plates 29A and 30A are modified in shape to extend more rearwardly. Also, a cover 100A and support beams 100A′ are added that covers a top and rearward area around the implement head 31A. The motor mount 36A is also modified to position the motor 38A more inwardly within the cavity within the implement cross tube 32A . . . which is possible since the stresses generated by the broom-type implement head 31A are somewhat less and different than the stresses generated by the “tiller type” implement head 31. At an opposite end of implement head 31A, the bearing 75A is mounted in a slot 75A′ to permit adjustment.

The implement head 31A can include different styles and patterns of bristles. The illustrated implement head 31A includes twelve rows of bristles 101A that extend across a length of the implement cross tube 32A. A flange bracket 102A is welded or otherwise secured to the implement cross tube 32A, and is attached to the inner end of the radially extending bristles 101A. The illustrated bristles 101A are formed by slitting a strip of rubber, such as a rubber belt or other highly durable rubber sheet material. Thus, the illustrated bristles 101A have a weight and provide substantial cleaning and rubbing energy when rotated as the implement head 31A is moved along a hard floor. By changing the angle of the rotating implement head by adjustment through use of the hydraulic actuator 61A/62A, the implement 20A can be used to move debris laterally toward one side or the other side.

The implement 20B (FIGS. 13-14) includes a power-rotated silage facer incorporated into a bucket to load ensilage onto the bucket. Buckets for working vehicles (21) are known and are commercially available, including ones that incorporate mounts for attachment to the lift arms of working vehicles. The illustrated bucket 110B includes a bottom wall 111B, rear wall 112B, and opposing side walls 113B forming a container for scooping and moving materials such as ensilage, hay, dirt, and the like. An implement-carrying frame 114B is U-shaped and includes right and left side arms 115B pivoted to the side walls 113B at lower rear location 116B. The outer ends 117B of the arms 115B are enlarged, and an implement cross tube 118B is fixed to the outer ends 117B and extends between a top location of the outer ends 117B between the arms 115B. A relatively large hole is formed in one of the ends 117B for receiving the drive assembly 35B, and a plurality of bolt holes are formed around the large hole for attachment to the flange 80B of the motor mount 36B. A smaller hole is formed in the other end 117B for receiving the bearing 75B.

The implement head 31B includes a rotatable implement cross tube 32B with radially-extending tines 120B for pulling ensilage loose and into the bucket 110B as the head 31B is rotated. The illustrated head 31B includes a center tubular section 121B having a relatively smaller cross section (which saves weight), and having axially-aligned enlarged cylindrical end sections 122B. At the end near the bearing 75B, a plate (not specifically shown, but see bearing arrangements in FIG. 4) covers the end and an axle extends from the plate for engaging the bearing 75B. At the end near the drive assembly 35B, a driven member (see driven member 41 in FIGS. 4 and 10) is supported by an adapter within the enlarged end section 112B. The drive assembly 35B including the motor 38B are secured to the outer end 117B, including telescopingly engaging the drive member 40B with the driven member and the coupler inside of head cross tube 120B. A cover 124B is positioned on the outer end 117B to cover and protect the motor 38B.

A pair of actuators 126B are positioned on each side of the bucket 110B parallel the. arms 115B. Specifically, the actuators 126B each include a cylinder 128B pivoted to a bracket 129B at a location generally near the rear pivot location 116B, and further each include an extendable rod 129B pivoted by a bracket 130B near a forward end of the arms 115B. By retracting the rods 129B, the arms 115B (and implement head 31B) are moved upwardly with an arcuate motion across a front of the bucket 110B. When extended, a reverse motion occurs. By this arrangement, the bucket 110B can be positioned adjacent a front of an ensilage stack by the working vehicle (21). Then, while the implement head 31B is being rotated, the actuators 126B are operated to move the implement head 31B across the face of the ensilage stack with a sweeping motion. The operation of the tines 120B causes ensilage to be pulled loose and fall into the bucket 110B.

It is noted that the same arrangement of implement 20B can be used for other loading operations for loading the bucket 110B. For example, it can be used to load hay, dirt, gravel or sand onto the bucket. In such circumstance, it may be desirable to modify the tines to an optimal shape for the particular task to be performed. It is contemplated that such modifications are within a scope of the present invention.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. An implement adapted for mounting on a powered vehicle, comprising:
a frame adapted for attachment to the powered vehicle and including opposing side supports;
a rotatable implement head extending between the side supports and defining a cavity in at least one end of the implement head; and
a motor positioned at least partially within the cavity in a protected position, the motor being coupled to the implement head for rotatably driving the implement head.

2. The implement defined in claim 1, wherein the implement head includes a cross tube extending between the side supports.

3. The implement defined in claim 2, wherein the motor is designed to and does carry a weight of the cross tube at one end of the implement head.

4. The implement defined in claim 3, including a bearing on the side support at another end of the implement head that carries a weight of the cross tube at the other end.

5. The implement defined in claim 1, including a drive assembly that includes the motor and further that includes telescoping members that inter-engage, one of the telescoping members being connected to the motor and the other of the telescoping members being connected to the implement head.

6. The implement defined in claim 5, wherein the telescoping members include square tube sections that matably engage.

7. The implement defined in claim 6, including a sleeve coupler between the square tube sections.

8. The implement defined in claim 5, wherein the drive assembly includes a motor mount having a cylindrical flange in which the motor is partially positioned.

9. The implement defined in claim 8, wherein the drive assembly includes a drive hub engaging a rotating shaft of the motor and wherein one of the telescoping members engages the drive hub.

10. The implement defined in claim 1, wherein the motor is a hydraulic motor.

11. The implement defined in claim 1, wherein the frame includes an attachment frame and an implement-carrying frame operably supported for adjustment by the attachment frame.

12. The implement defined in claim 11, wherein the implement-carrying frame includes a cross tube rigidly connecting the side supports.

13. The implement defined in claim 11, wherein the implement-carrying frame is adjustably supported by the attachment frame for angular adjustment.

14. The implement defined in claim 11, wherein the implement-carrying frame is angularly/vertically adjustable and also angularly/horizontally adjustable on the attachment frame.

15. The implement defined in claim 11, wherein the frame also includes a sub-frame supporting the implement-carrying frame on the attachment frame.

16. The implement defined in claim 11, wherein the implement head includes radially-extending protrusions.

17. The implement defined in claim 11, wherein the implement head includes flexible protrusions designed to provide a sweeping action upon rotation of the implement head.

18. The implement defined in claim 1, wherein the frame incorporates a bucket shape that includes the side supports as ends of the bucket, and wherein the implement head is mounted for rotation near an open front of the bucket and is designed to load materials from a pile of material into the bucket.

19. An implement adapted for mounting on a powered vehicle, comprising:
a frame adapted for attachment to the powered vehicle and including opposing side support plates;
a rotatable implement head extending between the side support plates and defining an axis of rotation; and
a motor attached to one of the side support plates, the motor including a power-generating part positioned at least partially inboard of the one side support plate in a position generally aligned with the axis of rotation of the implement head so that an exterior portion of the motor extends axially outwardly from the one side support plate less than a length of the power-generating part of the motor, whereby the implement head can be positioned closer to an obstacle than the length of the motor even though the motor is positioned in-line with the axis of rotation of the implement head.

20. An implement adapted for mounting on a powered vehicle, comprising:
a frame adapted for attachment to the powered vehicle;
an implement head supported for rotation on the frame including a non-circular tubular driven member coupled to and adapted to rotatably drive the implement head; and
a drive assembly including a motor anchored to the frame, a non-circular tubular drive member shaped to fit telescopingly into the driven member, and a coupler shaped to fit matably between the driven member and the drive member to take up clearance therebetween.

21. The implement defined in claim 20, wherein the coupler is made of a plastic material.

22. An implement adapted for mounting on a powered vehicle, comprising:
a frame having a pair of spaced apart side support plates;
a rotatable implement head including a tube section defining a cavity inboard of and adjacent one of the side support plates;
a motor drive assembly including a motor; and
a mount having a first flange attached to the one side support plate and a tubular flange that extends telescopingly into the cavity from the one support plate, the motor being positioned at least partially within the tubular flange.
